(19) United States
(12) Patent Application Publication
(10) Pub. No.: US 2003/0173386 A1
(43) Pub. Date: Sep. 18, 2003

(54) Motorcycle helmet rack

(76) Inventor: Brian C. Scaccia, Tustin, CA (US)

Correspondence Address: MORLAND C FISCHER, 2030 MAIN ST, SUITE 1050, IRVINE, CA, 92614

(21) Appl. No.: 10/094,902

(22) Filed: Mar. 12, 2002

(51) Int. Cl. B62J 7/00; B62J 9/00; B62J 11/00

(52) U.S. Cl. 224/413; 224/427; 224/447

(57) ABSTRACT

A helmet rack to be affixed to the rear of a motorcycle to enable the operator and/or a passenger to be able to quickly and easily lock his riding helmet to the motorcycle when the motorcycle is at rest so as to avoid the inconvenience of having to carry the helmet from place-to-place with the risk that it might become lost or stolen. The helmet rack includes a pair of upright brace members connected to respective side brackets that usually support the passenger backrest above the rear fender of the motorcycle. With a helmet surrounding one of the pair of upright brace members, a rotatable closure bar is locked in a closed position so as to extend across the top ends of the pair of brace members to prevent a rotation of the closure bar and a removal of the rider's helmet from the helmet rack.

### BACKGROUND OF THE INVENTION

1. Field of the Invention.

This invention relates to an easy to use motorcycle helmet rack that is affixed to the rear of a motorcycle to provide a readily accessible location at which the helmet of a motorcycle rider may be reliably locked, whereby to avoid the inconvenience and worry of misplacing or losing the helmet when the motorcycle is not in use.

2. Background Art

Many states have enacted laws that require motorcycle operators and their passengers to wear protective helmets. Still other riders voluntarily wear a helmet for the protection it may add in the event of an accident. In either event, the motorcycle operator and/or his passenger are faced with the inconvenience of having to carry their relatively large and bulky helmets whenever the riders dismount and the motorcycle is at rest for a long period of time.

In some situations, a rider may misplace or forget to take his helmet with him from place-to-place. In other situations, the helmet could be stolen should the rider fail to regularly monitor its whereabouts. No convenient storage facility is known where a rider can safely stow his helmet when its use is temporarily not required while, at the same time, making the helmet readily available to the rider for a resumption of his trip.

### SUMMARY OF THE INVENTION

In general terms, a helmet rack is disclosed to be affixed to the rear of a motorcycle so that the operator of the motorcycle and/or his passenger may reliably lock their riding helmets to the motorcycle at those times when the motorcycle is not in use and the helmets are not required. By virtue of the foregoing, riders will be able to quickly and easily secure their helmets directly to the motorcycle so as to avoid the inconvenience of having to carry the helmets from place-to-place with the risk that they might become lost or stolen.

The motorcycle helmet rack includes a pair of parallel aligned upright brace members that are affixed to respective side brackets that usually support the passenger backrest above the rear fender of the motorcycle. A cross bar is fixedly connected between the pair of brace members to lend lateral support to the helmet rack. One end of a rotatable closure bar is pivotally connected to the top end of a first of the pair of brace members by means of a pivot pin. The opposite free end of the rotatable closure bar is locked in a closed position in detachable mating engagement with the top end of the second of the pair of brace members by means of a lock. When the lock is removed from the helmet rack, the closure bar is rotated upwardly around the pivot pin to an open position so that the free end of the bar is detached from the second brace member. With the closure bar in the open position, the operator and/or his passenger may place a riding helmet around one of the upright brace members of the helmet rack. The rotatable closure bar is then rotated back to the closed position so as to be returned to its mating engagement with the second brace member. The lock is once again installed on the helmet rack to lock the closure bar in place between the top ends of the pair of upright brace members and thereby prevent an unauthorized removal of the helmet therefrom.

### BRIEF DESCRIPTION OF THE DRAWINGS

FIG. 1 shows the motorcycle helmet rack of this invention affixed to the rear of a motorcycle for carrying a riding helmet;

FIGS. 2 and 3 show details of the helmet rack attached to the existing side brackets that are usually used to support the passenger backrest of the motorcycle of FIG. 1;

FIG. 4 shows the helmet rack assembly prior to its attachment to the rear of the motorcycle;

FIG. 5 is a partial top plan view of the helmet rack taken in the direction of reference lines 5-5 of FIG. 4;

FIG. 6 is a partial top plan view of the helmet rack taken in the direction of the reference lines 6-6 of FIG. 4;

FIG. 7 shows a rotatable closure bar of the helmet rack located in a closed position; and

FIGS. 8 and 9 show the rotatable closure bar of FIG. 7 raised to an open position at which a helmet may be either removed from or placed upon the helmet rack.

### DETAILED DESCRIPTION

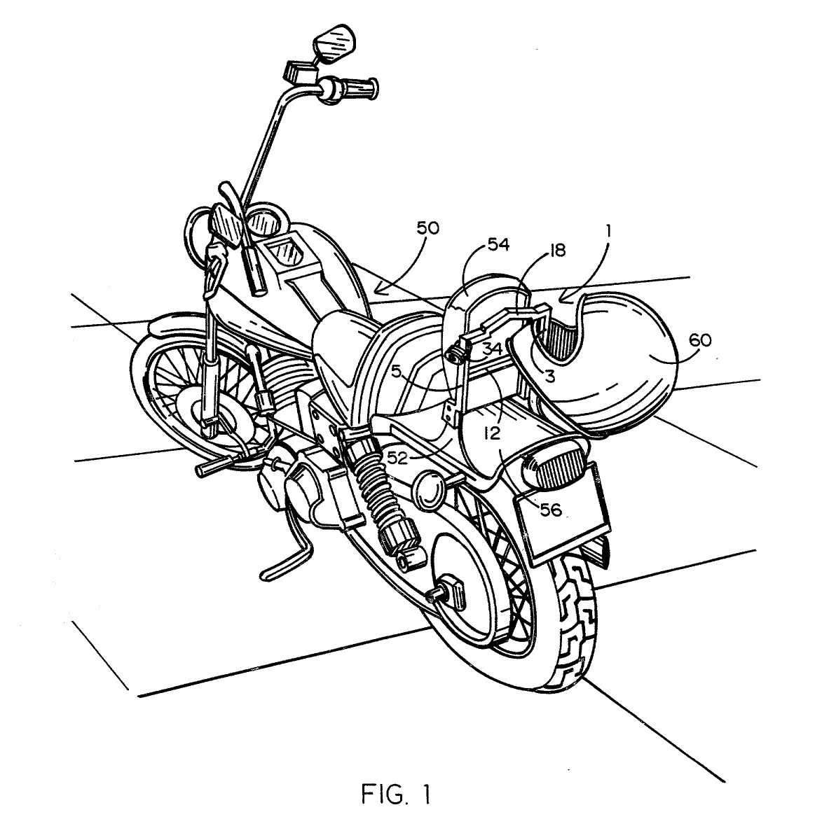

FIG. 1 of the drawings illustrates a motorcycle 50 to which the helmet rack 1 of this invention is applicable. Although the motorcycle 50 can be of any kind and purchased from any manufacturer, the helmet rack 1 is shown in the drawings as being attached to a motorcycle of the type having a passenger seat located behind the front seat for the operator. As will be explained in greater detail hereinafter, the helmet rack 1 is attached to the existing side brackets 52 that normally support the passenger backrest 54 above the rear fender 56 of the motorcycle 1. By virtue of the helmet rack 1, a motorcycle operator and/or a passenger will be able to quickly and easily lock his helmet 60 directly to the motorcycle at a readily available location behind the passenger backrest 54 so as to avoid the inconvenience of having to carry the helmet 60 from place-to-place with the risk that the helmet will become lost or stolen.

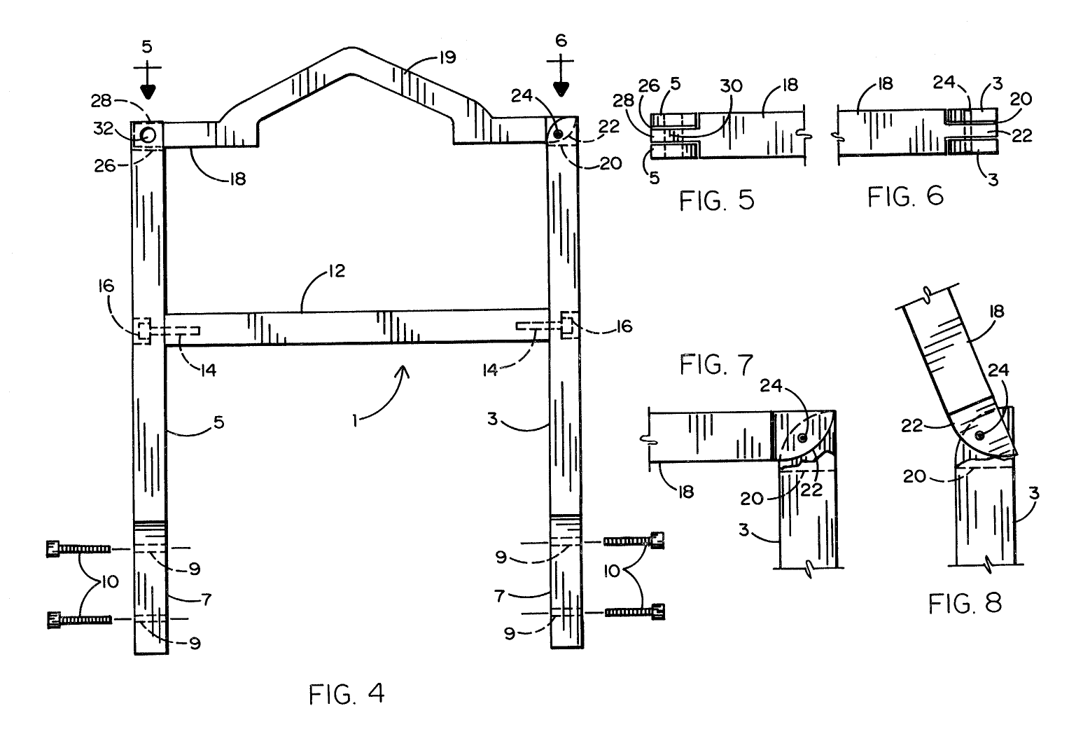

Referring concurrently now to FIGS. 2-6 of the drawings, the details of the helmet rack 1 are now disclosed. The helmet rack 1 is preferably manufactured from a tamper resistant metal, although the actual material by which to manufacture helmet rack 1 is not to be regarded as a limitation of this invention. The helmet rack 1 includes a pair of upright brace members 3 and 5 that extend in spaced parallel alignment with one another from the side brackets 52 for backrest 54. For the usual motorcycle, the pair of upright brace members 3 and 5 will be spaced from one another by approximately seven inches.

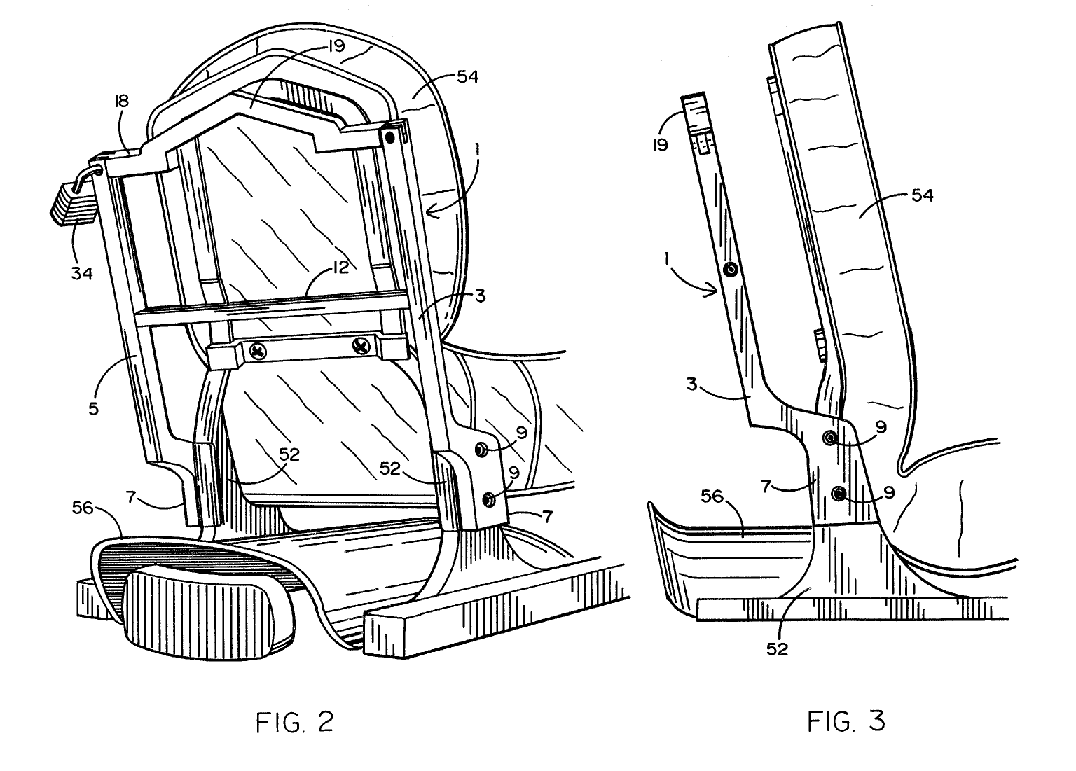

The bottom of each brace member 3 and 5 has a relatively wide, inwardly flared base 7. A pair of bolt holes 9 are machined through the base 7 of each brace member 3 and 5 to accommodate suitable fasteners (e.g. bolts) 10. As is best shown in FIGS. 2 and 3, the fasteners 10 affix the upright brace members 3 and 5 of helmet rack 1 to the outside of the respective side brackets 52 for the passenger backrest 54 of the motorcycle 50 (of FIG. 1).

A cross-bar 12 extends between the pair of upright brace members 3 and 5 to lend lateral support to the helmet rack 1. Opposite ends of the cross-bar 12 are affixed to the brace members 3 and 5 by means of fasteners (e.g. bolts) 14 received through respective bolt holes 16.

A rotatable closure bar 18 extends across the helmet rack 1 between the top ends of the pair of upright brace members 3 and 5. The rotatable closure bar 18 includes a convenient arch shaped handle 19 located at the midpoint thereof by which the closure bar 18 may be gripped and manipulated (i.e. rotated) by a rider.

The top end of one upright brace member 3 from the pair of parallel aligned brace members 3 and 5 has a notch 20 machined therein (best shown in FIG. 6). A first end of the rotatable closure bar 18 has a narrow tongue 22 projecting therefrom. With the tongue 22 of the closure bar 18 located within the notch 20 that is formed at the top end of brace member 3, a pivot pin 24 is inserted through the brace member 3 and the tongue 22, whereby the first end of the closure bar 18 is pivotally attached to the upright brace member 3.

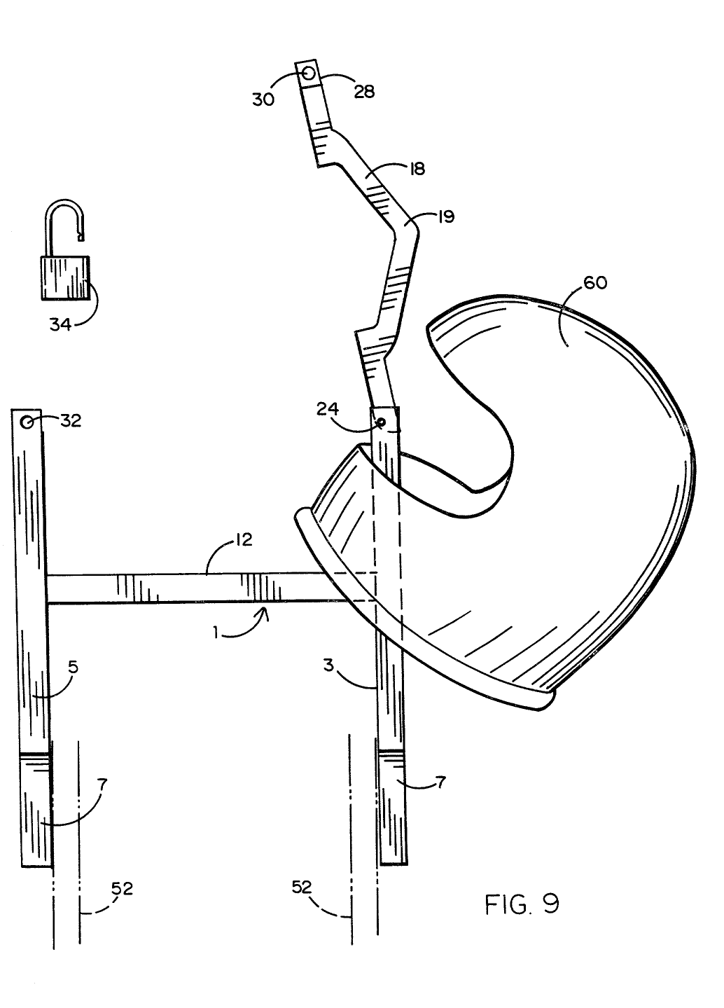

The top end of the second brace member 5 of the pair of parallel aligned brace members 3 and 5 also has a notch 26 machined therein (best shown in FIG. 5). The second end of the rotatable closure bar 18 also has a tongue 28 projecting therefrom. A hole 30 is formed in the tongue 28 of closure bar 18. A corresponding pair of holes 32 are formed in the top end of the brace member 5. With the tongue 28 of closure bar 18 located within the notch 26 formed at the top end of brace member 5, the holes 30 and 32 will be axially aligned with one another to receive therethrough the clasp of a lock (designated 34 in FIG. 9) so as to releasably hold the closure bar 18 in a locked condition between the top ends of the pair of upright brace members 3 and 5.

The operation of the helmet rack 1 of this invention is described while referring concurrently to FIGS. 7-9 of the drawings. FIG. 7 shows the rotatable closure bar 18 lying in a closed position across the helmet rack 1 so as to be locked in place between the pair of upright brace members 3 and 5. As is best shown in FIG. 2, the clasp of a conventional lock 34 is received through the axially aligned holes 30 and 32 that are formed in the mating ends of the closure bar 18 and the brace member 5 in order to prevent a rotation of the closure bar 18 and access to the interior of the helmet rack 1.

When it is desirable to open the helmet rack 1 to either add or remove a rider's helmet 60, the lock 34 is first removed from the helmet rack. Next, the now free end of the rotatable closure bar 18 is rotated around the pivot pin 24 that extends between the mating engagement of the opposite end of the closure bar 18 with the brace member 3. That is to say, the rider pulls upwardly on the closure bar 18 at the gripping handle 19 thereof so as to cause the closure bar 18 to rotate from the closed position of FIG. 7 to the open position of FIGS. 8 and 9. At this point, a rider can place his helmet 60 around either one of the pair of upright brace members 3 and 5 so that it will be seated atop the cross bar 12.

With a helmet 60 positioned around one of the brace members 3 and 5, the rider once again grasps the gripping handle 19 and pushes downwardly thereon to cause the rotatable closure bar 18 to rotate from the open position of FIGS. 8 and 9 back to the closed position of FIG. 7. The lock 34 is returned to the helmet rack 1 in the manner shown in FIGS. 1 and 2 so as to retain the mating ends of the upright brace member 5 and the closure bar 18 in locking engagement with one another. It may be appreciated that the operator and/or a passenger may now leave his motorcycle without having to constantly worry about carrying a relatively large and bulky riding helmet and having the helmet lost or stolen. The helmets will otherwise be safely and reliably secured directly to the back of the motorcycle by means of the easy to operate helmet rack 1 so as to remain readily accessible to the operator and his passenger when needed. Accordingly, some of the inconveniences of having to wear a motorcycle riding helmet are now advantageously avoided.

The helmet rack of this invention has been described above as having particular application for use with a motorcycle. However, it is to be understood that the helmet rack also has application with other vehicles (e.g. bicycles, off-road vehicles, snow mobiles, and the like) where riders typically wear helmets that are to be stowed at a secure location when the vehicle is not in use.

I claim:

1. A helmet rack to be affixed to a vehicle in order to enable a rider's helmet to be securely attached to the vehicle, said helmet rack comprising first and second brace members affixed to the vehicle and extending in spaced alignment with one another so that the helmet can surround one of said first and second brace members, a closure bar extending in a closed position between the first and second brace members above the helmet, and a lock to retain the closure bar in said closed position to prevent a removal of the helmet from the one of said first and second brace members.

2. The helmet rack recited in claim 1, wherein said first and second brace members extend from the vehicle in spaced parallel alignment with one another.

3. The helmet rack recited in claim 1, further comprising a cross bar connected between said first and second brace members to provide lateral support for said helmet rack, the helmet for surrounding the one of said first and second brace members being retained at a location between said closure bar and said cross-bar.

4. The helmet rack recited in claim 1, wherein said closure bar is pivotally connected at one end thereof to said first brace member.

5. The helmet rack recited in claim 4, wherein the opposite end of said closure bar is detachably connected to said second brace member by means of said lock, said closure bar adapted to be rotated from said closed position between said first and second brace members to an open position detached from said second brace member when said lock is unlocked to enable the helmet to be removed from the one of said first and second brace members.

6. The helmet rack recited in claim 5, further comprising a handle extending from said closure bar to be grasped by a rider so as to enable said closure bar to be rotated between the closed and open positions.

7. In combination:
a motorcycle including a front seat, a back seat and a pair of side brackets that cooperate with the back seat to support said back seat upon the motorcycle; and
a helmet rack to be affixed to the motorcycle in order to enable a rider's helmet to be securely attached thereto, said helmet rack comprising first and second brace members affixed to respective ones of said pair of side brackets so that the helmet can surround one of said first and second brace members, a rotatable closure bar extending in a closed position between the first and second brace members above the helmet, and a lock to retain the closure bar in said closed position so as to prevent a rotation of said closure bar and a removal of the helmet from the one of said first and second brace members.
